(19) United States
(12) Patent Application Publication
(10) Pub. No.: US 2015/0322793 A1
(43) Pub. Date: Nov. 12, 2015

(54) METHOD FOR TURBINE WHEEL BALANCE STOCK REMOVAL

(71) Applicant: BorgWarner Inc., Auburn Hills, MI (US)

(72) Inventors: Lauro TAKABATAKE, Campinas (BR); Reinaldo PAULINO, Campinas (BR)

(21) Appl. No.: 14/410,140

(22) PCT Filed: Jun. 28, 2013
(86) PCT No.: PCT/US2013/048417

§ 371 Date: Dec. 22, 2014

Related U.S. Application Data
(60) Provisional application No. 61/667,174, filed on Jul. 2, 2012.

(51) Int. Cl. F01D 5/02; F02C 6/12

(52) U.S. Cl. CPC F01D 5/027; F02C 6/12

(57) ABSTRACT

A turbine wheel (10) for a turbocharger includes a hub (12) extending in an axial direction between a nose (14) and a back-wall (22). The hub (12) defines an axis of rotation (28) extending in the axial direction and the back-wall (22) includes a peripheral edge (20). A plurality of turbine blades (26) is coupled to the hub (12) and is disposed in a circumferential direction generally at equal intervals around the axis of rotation (28). At least one scallop (44, 48) is formed in the peripheral edge (20) of the back-wall (22) for balancing the turbine wheel (10). The at least one scallop (44, 48) is positioned along the peripheral edge (20) such that the peripheral edge (20) is not symmetrical in the circumferential direction about the axis of rotation (28).

### CROSS-REFERENCE TO RELATED APPLICATIONS

This application claims priority to and all the benefits of U.S. Provisional Application No. 61/667,174, filed on Jul. 2, 2012, and entitled “Method For Turbine Wheel Balance Stock Removal.”

### BACKGROUND OF THE INVENTION

1. Field of the Invention

The present invention relates to a method for balancing a shaft-and-wheel assembly of a turbocharger. More particularly, the present invention relates to a method of removing balance stock from a turbine wheel having a “fullback” back-wall.

2. Description of Related Art

A turbocharger is a type of forced induction system used with internal combustion engines. Turbochargers deliver compressed air to an engine intake, allowing more fuel to be combusted, thus boosting an engine's horsepower without significantly increasing engine weight. Thus, turbochargers permit the use of smaller engines that develop the same amount of horsepower as larger, normally aspirated engines. Using a smaller engine in a vehicle has the desired effect of decreasing the mass of the vehicle, increasing performance, and enhancing fuel economy. Moreover, the use of turbochargers permits more complete combustion of the fuel delivered to the engine, which contributes to the highly desirable goal of a cleaner environment.

Turbochargers typically include a turbine housing connected to the engine's exhaust manifold, a compressor housing connected to the engine's intake manifold, and a center bearing housing coupling the turbine and compressor housings together. Referring to FIG. 1, a turbine wheel 100 is disposed in the turbine housing and is rotatably driven by an inflow of exhaust gas supplied from the exhaust manifold. A shaft 102 is rotatably supported in the center bearing housing and connects the turbine wheel 100 to a compressor impeller 104 in the compressor housing so that rotation of the turbine wheel 100 causes rotation of the compressor impeller 104. The shaft 102 connecting the turbine wheel 100 and the compressor impeller 104 defines an axis of rotation 105. As the compressor impeller 104 rotates, it increases the air mass flow rate, airflow density and air pressure delivered to the engine's cylinders via the engine's intake manifold.

It is well known in the art that the turbine wheel 100 is one of the most expensive components of the turbocharger. The turbine wheel 100 is expensive because it is typically cast from a nickel based superalloy with over seventy percent (70%) by weight in nickel. This equates to approximately five percent (5%) of the weight of the entire turbocharger. Thus, it is desirable for the turbine wheel 100 to have a long lifecycle. Since the turbine wheel 100 is subjected to very high rotational speeds, typically ranging from 80,000 rpm up to 300,000 rpm, rotational balance of the turbine wheel 100 is critical for both performance and lifecycle of both the turbine wheel 100 and the turbocharger.

However, the rotational balance of the turbine wheel 100 is unknown until it is part of a finished shaft-and-wheel assembly, and unfortunately, the balancing step is generally the last operation in the manufacture of the shaft-and-wheel assembly. For one example, a turbine wheel casting may be held in a chuck to drill a center hole 106 in a nose 108 on a front side of the turbine wheel casting. The shaft 102 is then welded to a weld boss 110 on a back side of the turbine wheel casting. After heat treating the weld, the shaft-and-wheel assembly is machined, including finish machining a plurality of turbine blades 112 on the turbine wheel 100 itself. A distal end 114 of the shaft 102 is threaded and then the shaft-and-wheel assembly is balanced. Thus, if the shaft-and-wheel assembly is scrapped due to balance problems, a high degree of non-recoverable cost has already been expended.

The shaft-and-wheel assembly is typically balanced by removing material from the turbine wheel 100, otherwise known as balance stock removal, generally in two locations. Referring to FIGS. 1 through 2B, the turbine wheel 100 is shown having a “fullback.” It is understood that the “fullback” terminology relates to a back-wall 116 having a hubline 118 that extends all the way to an inlet tip 120 of the turbine blades 112, thereby defining an outer diameter Dl. Material is removed from the side faces of the nose 108 in an area indicated as 122 in FIG. 2A. Material is also removed from a surface 124 of the back-wall 116 in one or more zones. More specifically, in the embodiment shown in FIG. 2B, material is removed from a first zone 126 and a second zone 128, both of which are bounded in a circumferential direction by an angle θ. The first zone 126 on the surface 124 of the back-wall 116 is disposed toward a periphery of the back-wall 116 and is bounded in a radial direction by an inner boundary 130 and an outer boundary 132. The inner boundary 130 has a radius that is typically approximately thirty-six percent (36%) of the outer diameter Dl of the back-wall 116. The outer boundary 132 is at the periphery of the back-wall 116. Within the confines of the first zone 126, the material is removed from the surface 124 of the back-wall 116 to a proprietary maximum depth.

The second zone 128 on the surface 124 of the back-wall 116 is disposed toward the weld boss 110 and is bounded in the radial direction by an inner boundary 134 and an outer boundary 136. The inner boundary 134 is constrained by a shape and entrance angle of a cutting tool used to remove the material from the surface 124 of the back-wall 116 so that the cutting tool does not cut into a transition surface between the weld boss 110 and the back-wall 116. The outer boundary 136 is spaced apart in the radial direction from the inner boundary 130 of the first zone 126. Within the confines of the second zone 128, the material is removed from the surface 124 of the back-wall 116 to a proprietary maximum depth.

Due to material properties of the turbine wheel 100 it is difficult to remove material from the surface 124 of the back-wall 116 smoothly. As a result, removing material from the surface 124 of the back-wall 116 may introduce stress risers in the remaining material which have the potential to cause fatigue failures in the turbine wheel 100. Similarly, it is difficult to remove material to a consistent depth as a high degree of cutting tool force is required and the stiffness of the back-wall 116 varies, particularly as the cutting tool traverses from an area of the back-wall 116 that is supported by the turbine blades 112 to an area that is unsupported by the turbine blades 112. As such, it is desirable to minimize the amount of material that is removed from the surface 124 of the back-wall 116, especially in the second zone 128 adjacent to the weld boss 110, which is subject to high centrifugal stress during operation of the turbocharger.

Referring to FIGS. 3A and 3B, it is also well known that a turbine wheel 140 may include “scallops” 142 in a back-wall 144 to reduce the moment of the turbine wheel 140. Scallops 142 refer to cutout portions in a peripheral edge 146 of the back-wall 144 between individual turbine blades 148. The scallops 142 primarily serve to reduce the moment of inertia of the turbine wheel 140 by removing material in the radially outermost area of the turbine wheel 140. The scallops 142, however, play no roll in balancing a shaft-and-wheel assembly because the material is removed from the back-wall 144 such that the peripheral edge 146 is symmetrical in a circumferential direction about an axis of rotation 150 of the turbine wheel 140. In other words, the turbine wheel 140 includes a center of symmetry coincident with the axis of rotation 150 wherein for any point on the peripheral edge 146 of the back-wall 144 an identical point exists diametrically opposite therefrom. Therefore, if the turbine wheel 140 is unbalanced, it will remain unbalanced regardless of the scallops 142. Examples of turbine wheels with scallops are disclosed in U.S. Pat. No. 7,771,170 and European Patent Application Publication No. 1 462 607.

It is appreciated, that balancing a shaft-and-wheel assembly is a function of the mass of material removed from a turbine wheel and the distance from an axis of rotation of the shaft-and-wheel assembly to a center of gravity of the material removed. Thus, the greater the distance from the axis of rotation to the center of gravity of the material removed, the less material that has to be removed. It is desirable to provide a method of removing material to balance a shaft-and-wheel assembly that minimizes the amount of material that is removed from a back-wall of a turbine wheel.

### SUMMARY OF THE INVENTION

According to a first embodiment of the invention, a turbine wheel for a turbocharger includes a hub extending in an axial direction between a nose and a back-wall. The back-wall includes a peripheral edge and the hub defines an axis of rotation extending in the axial direction. A plurality of turbine blades is coupled to the hub and the turbine blades are disposed in a circumferential direction generally at equal intervals around the axis of rotation. At least one multi-pass scallop in the peripheral edge of the back-wall balances the turbine wheel. The multi-pass scallop is elongated in the circumferential direction such that material is removed from the back-wall over a designated angle, which requires multiple passes of a cutting tool. The multi-pass scallop is positioned along the peripheral edge such that the peripheral edge is not symmetrical in the circumferential direction about the axis of rotation.

According to a second embodiment of the invention, a turbine wheel for a turbocharger includes a hub extending in an axial direction between a nose and a back-wall. The back-wall includes a peripheral edge and the hub defines an axis of rotation extending in the axial direction. A plurality of turbine blades is coupled to the hub and the turbine blades are disposed in a circumferential direction generally at equal intervals around the axis of rotation. At least one single-pass scallop in the peripheral edge of the back-wall balances the turbine wheel. The single-pass scallop is generally semi-circular such that material is removed from the back-wall with a single pass of a cutting tool. The single-pass scallop is positioned along the peripheral edge such that the peripheral edge is not symmetrical in the circumferential direction about the axis of rotation.

According to a third aspect of the invention, a method for balancing a turbine wheel includes the step of selectively removing material from a peripheral edge of a back-wall between a plurality of turbine blades such that the peripheral edge is not symmetrical in a circumferential direction about an axis of rotation of the turbine wheel.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a side cross-sectional view of a turbine wheel, a compressor impeller, and a shaft connecting the turbine wheel and compressor impellor according to the prior art;

FIG. 2A is a side view of a turbine wheel with a “fullback” back-wall illustrating first and second zones for balance stock removal according to the prior art;

FIG. 2B is a rear view of the turbine wheel in FIG. 2A illustrating the first and second zones for balance stock removal;

FIG. 3A is a front view of a turbine wheel having a back-wall with “scallops” according to the prior art;

FIG. 3B is a front perspective view of the turbine wheel in FIG. 3A;

FIG. 4A is a rear view of a turbine wheel with a “fullback” back-wall illustrating a first zone for balance stock removal and a multi-pass scallop according to a first embodiment of the invention;

FIG. 4B is a cross-sectional view taken along lines 4B-4B in FIG. 4A;

FIG. 4C is an enlarged view of the multi-pass scallop shown in FIG. 4A;

FIG. 5A is a rear view of a turbine wheel with a “fullback” back-wall illustrating a first zone for balance stock removal and a single-pass scallop according to a second embodiment of the invention;

FIG. 5B is a cross-sectional view taken along lines 5B-5B in FIG. 5A; and

FIG. 5C is an enlarged view of the single-pass scallop shown in FIG. 5A.

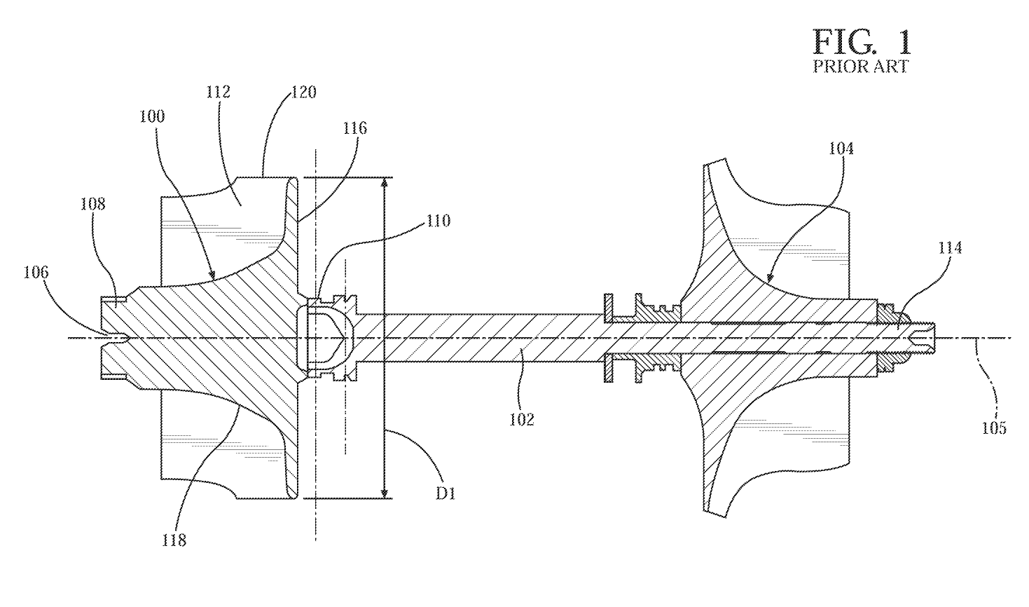

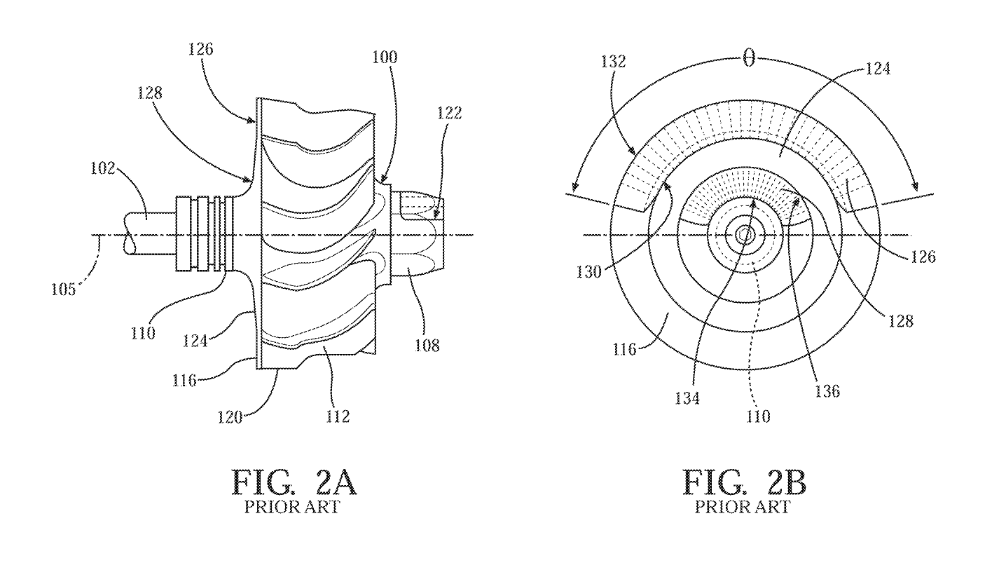

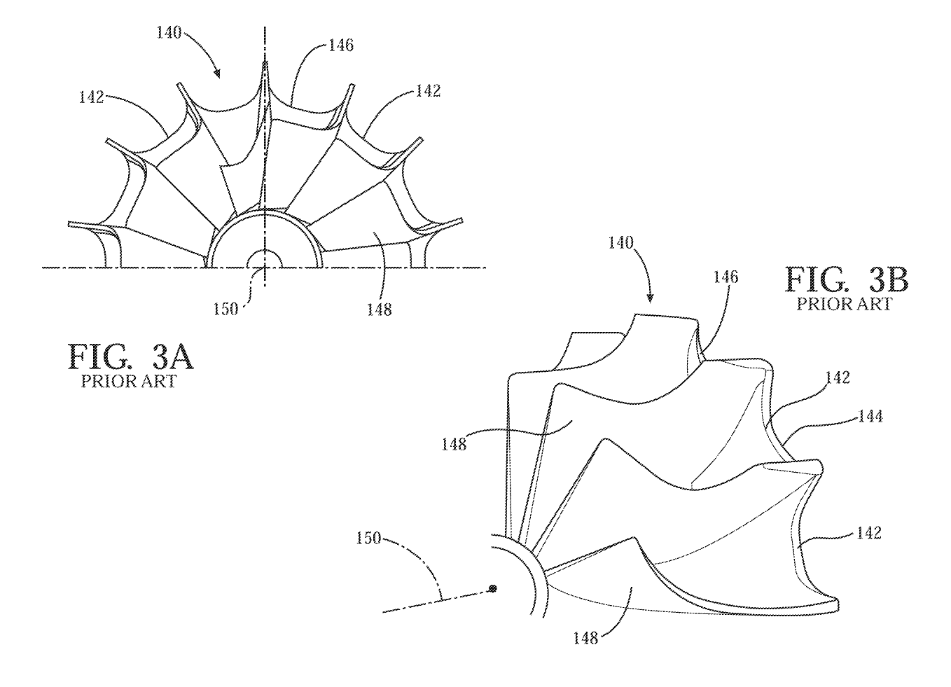

### DETAILED DESCRIPTION OF THE EMBODIMENTS

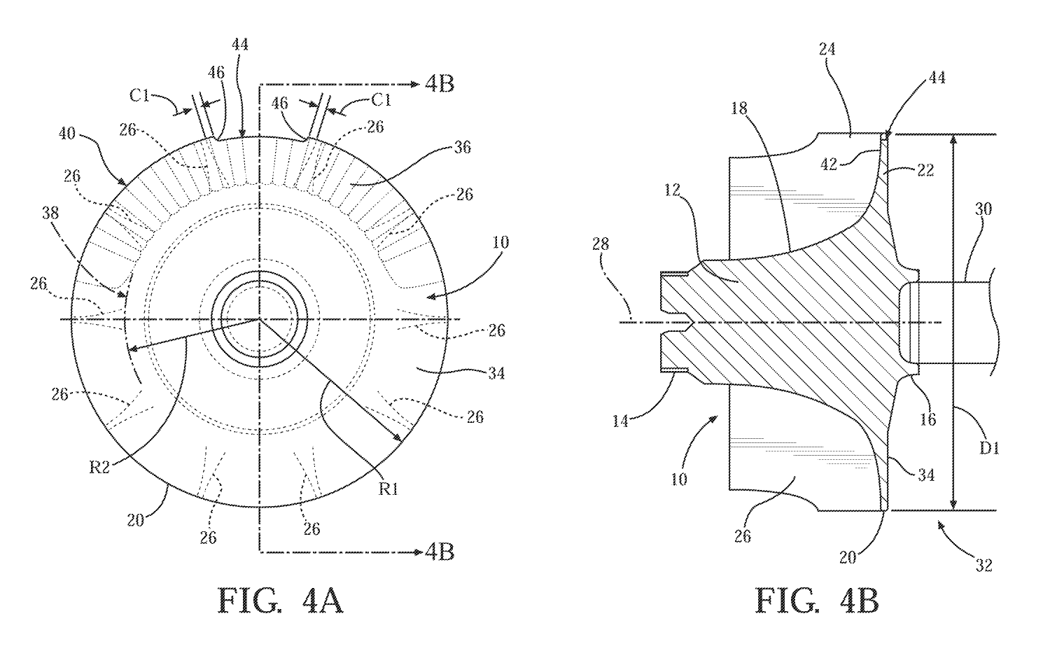

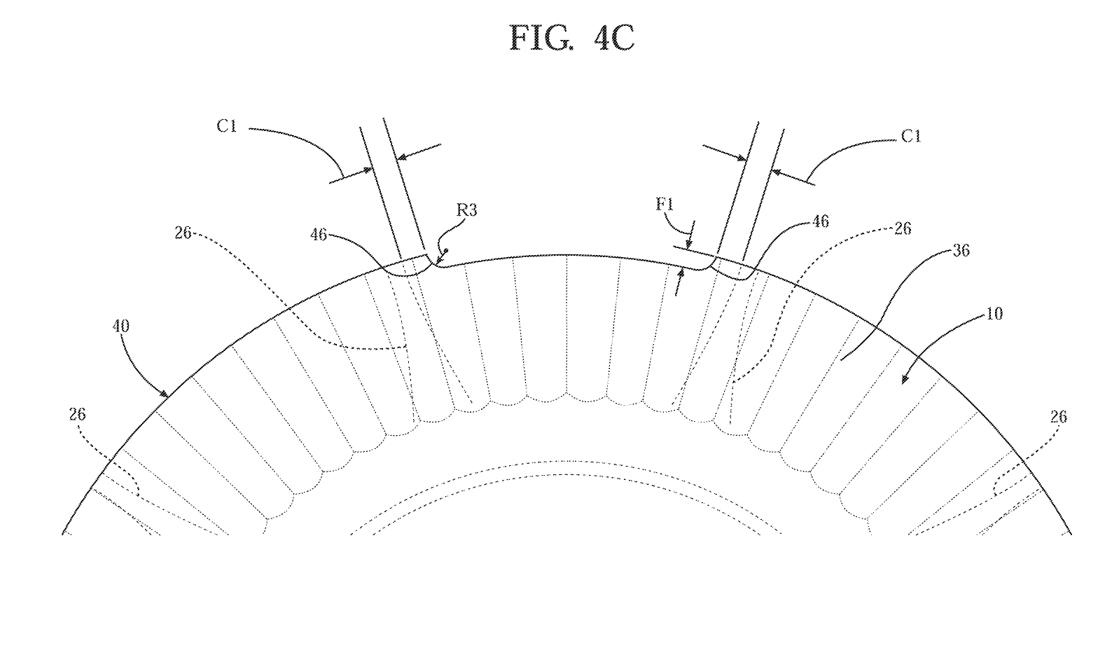

Referring to FIGS. 4A and 4B, a turbine wheel for a turbocharger is shown generally at 10. The turbine wheel 10 includes a hub 12 extending in an axial direction between a nose 14 on a front side of the turbine wheel 10 and a weld boss 16 on a back side of the turbine wheel 10. The hub 12 defines a hubline 18 that extends in the axial direction from a point generally adjacent the nose 14 and then diverges outward in a radial direction to a peripheral edge 20 of a back-wall 22. The peripheral edge 20 of the back-wall 22 coincides with an inlet tip 24 of a plurality of turbine blades 26, thereby defining a “fullback” turbine wheel 10. The peripheral edge 20 of the back-wall 22 defines an outer diameter Dl having a first radius R1 corresponding thereto. The turbine blades 26 are disposed in a circumferential direction generally at equal intervals around an axis of rotation 28 of the turbine wheel 10.

A shaft 30 is welded to the weld boss 16 of the turbine wheel 10 to form a shaft-and-wheel assembly 32. It is appreciated that the shaft-and-wheel 32 generally requires balancing before attaching a compressor impeller (not shown) to a distal end of the shaft 30 and installing the combination in the turbocharger. In order to balance the shaft-and-wheel assembly 32, material will typically be selectively removed from the turbine wheel 10. Depending on the amount of balancing required, material may be removed from the turbine wheel 10 in one or more locations.

As is well known in the art, material may be removed from side faces of the nose 14. Material may also be removed from a surface 34 of the back-wall 22 in one or more zones. Generally, material will be removed from the surface 34 of the back-wall 22 in a zone 36 that is bounded in the circumferential direction by an angle θ. In the embodiment shown, the angle θ is less than 180 degrees; however, it is appreciated that the angle θ may be any angle that is less than 360 degrees without varying from the scope of the invention. The zone 36 on the surface 34 of the back-wall 22 is disposed toward the peripheral edge 20 of the back-wall 22 and is bounded in the radial direction by an inner boundary 38 and an outer boundary 40. In one embodiment, the inner boundary 38 has a second radius R2 that is approximately thirty-six percent (36%) of the outer diameter Dl of the back-wall 22. The outer boundary 40 is at the peripheral edge 20 of the back-wall 22. Within the confines of the zone 36, material is removed from the surface 34 of the back-wall 22 to a proprietary maximum depth. It is appreciated that there may be one or more zones 36 spaced apart in the radial and/or circumferential directions. It is further appreciated that the material removed from the surface 34 of the back-wall 22 is not removed in a manner that is symmetrical about the axis of rotation 28 as this would negate the balancing effect of the material that is removed.

According to the present invention, material may also be removed by one or more scallops which are cutout portions in the peripheral edge 20 of the back-wall 22. It is appreciated that the scallops may be positioned in the circumferential direction entirely inside the boundary of the zone 36, entirely outside the boundary of the zone 36, or both inside and outside the boundary of the zone 36 without varying from the scope of the invention. The scallops extend in the axial direction entirely through the back-wall 22 from the surface 34 to a deck face 42 of the hub 12.

In a first embodiment of the invention, a multi-pass or pattern scallop is shown generally at 44 in FIGS. 4A through 4C. The multi-pass scallop 44 is elongated in the circumferential direction such that material is removed from the back-wall 22 over a designated angle, which requires multiple passes with a cutting tool. A maximum angle for each multi-pass scallop 44 is defined between two turbine blades 26 that are adjacent such that there is a first distance C1 between an end 46 of the multi-pass scallop 44 and a fillet radius where the turbine blade 26 intersects the deck face 42 of the hub 12. Each multi-pass scallop 44 can extend in the circumferential direction over any angle up to the maximum angle without varying from the scope of the invention. The first distance C1 between the end 46 of the multi-pass scallop 44 and the fillet radius of the turbine blade 26 is at least approximately 0.5 millimeters. It is appreciated that the back-wall 22 is subject to high stress conditions near the turbine blades 26. As such, the first distance C1 is selected to avoid crack initiation at the ends 46 of the multi-pass scallop 44. A first depth F1 of each multi-pass scallop 44 is generally approximately 1.0 millimeter. Further, the ends 46 of each multi-pass scallop 44 define an arcuate portion having a third radius R3 which is generally approximately 1.0 millimeter. It is appreciated that these boundaries define the amount of material which is removed from the back-wall 22 for each multi-pass scallop 44. It is contemplated that other boundaries may be selected without varying from the scope of the invention. It is also contemplated that more than one multi-pass scallop 44 may be positioned between two turbine blades 26 that are adjacent without varying from the scope of the invention. The multi-pass scallops 44 are positioned along the peripheral edge 20 of the back-wall 22 such that the peripheral edge 20 is not symmetrical in the circumferential direction about the axis of rotation 28 as this would negate the balancing effect of the multi-pass scallops 44.

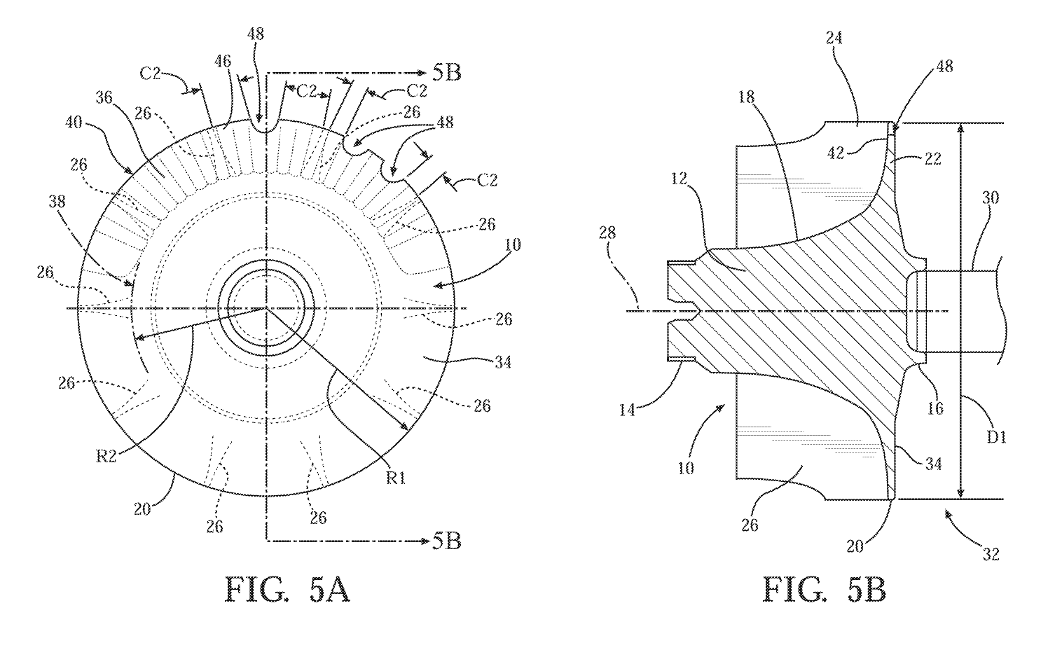

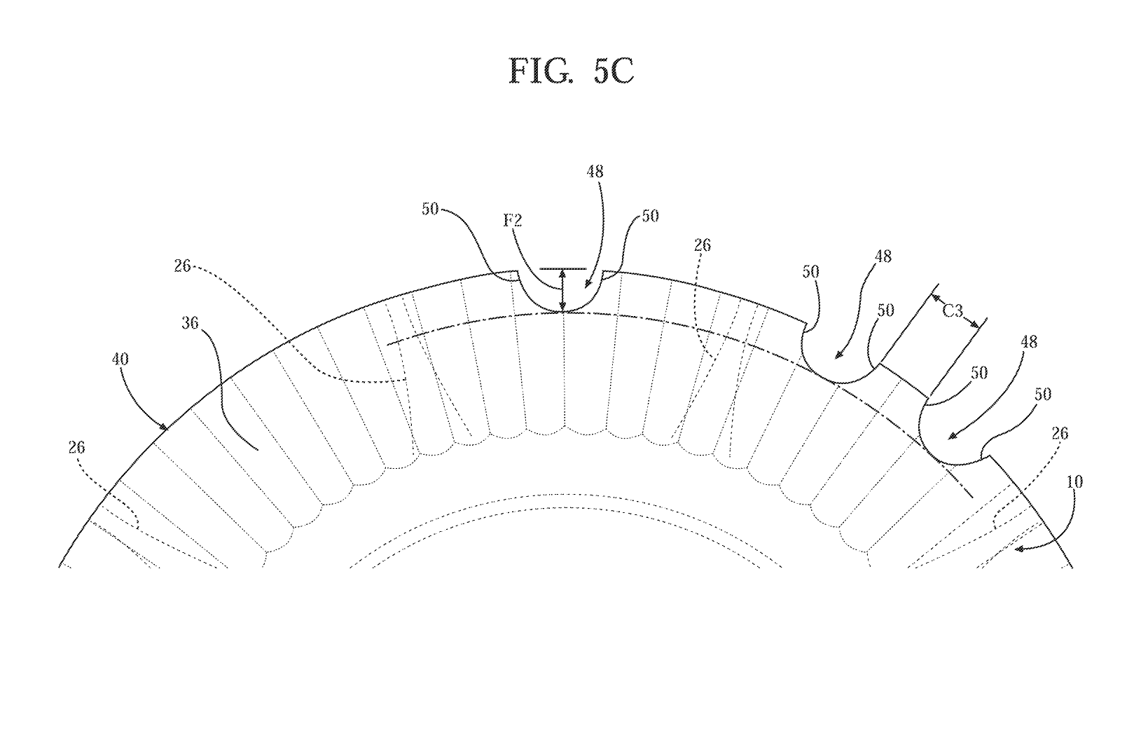

In a second embodiment of the invention, a single-pass scallop is shown generally at 48 in FIGS. 5A through 5C. The single-pass scallop 48 is generally semi-circular such that material is removed from the back-wall 22 with a single pass of a cutting tool. There is a second distance C2 between a side 50 of the single-pass scallop 48 and the fillet radius where the turbine blade 26 intersects the deck face 42 of the hub 12. The second distance C2 between the side 50 of the single-pass scallop 48 and the fillet radius of the turbine blade 26 is at least approximately 0.5 millimeters. Also, when there is more than one single-pass scallop 48 between two turbine blades 26 that are adjacent, there is a third distance C3 between the sides 50 of the single-pass scallops 48 that are adjacent. The third distance C3 between the sides 50 of the single-pass scallops 48 that are adjacent is at least approximately 2.0 millimeters. The third distance C3 is selected to avoid a localized high stress area in the back-wall 22. A second depth F2 of each single-pass scallop 48 is generally approximately 2.0 millimeters. It is appreciated that these boundaries define the amount of material which is removed from the back-wall 22 for each single-pass scallop 48. It is contemplated that other boundaries may be selected without varying from the scope of the invention. The single-pass scallops 48 are positioned along the peripheral edge 20 of the back-wall 22 such that the peripheral edge 20 is not symmetrical in the circumferential direction about the axis of rotation 28 as this would negate the balancing effect of the single-pass scallops 48.

If only a minor amount of balancing of the shaft-and-wheel assembly 32 is required, material may not need to be removed from the peripheral edge 20 of the back-wall 22 by one or more multi-pass scallops 44, as shown in the first embodiment, or one or more single-pass scallops 48, as shown in the second embodiment. Rather, it may sufficient to remove material from the surface 34 of the back-wall 22 to balance the shaft-and-wheel assembly 32.

Next, a method of balancing the shaft-and-wheel assembly 32 is described. The method of balancing the shaft-and-wheel assembly 32 includes the steps of: securing a turbine wheel casting in a chuck; drilling a center hole 52 in the nose 14 on the front side of the turbine wheel casting; welding the shaft 30 to the weld boss 16 on the back side of the turbine wheel casting; heat treating the weld; finish machining the shaft-and-wheel assembly 32; threading the distal end of the shaft 30; and balancing the shaft-and-wheel assembly 32. Balancing the shaft-and-wheel assembly 32 may include one or more of the following steps: selectively removing material from side faces of the nose 14; selectively removing material from one or more zones 36 on the surface 34 of the back-wall 22; and selectively removing material from the peripheral edge 20 of the back-wall 22 by machining one or more multi-pass scallops 44 or one or more single-pass scallops 48. It is contemplated that the method of balancing the shaft-and-wheel assembly 32 may not include all of the steps described above without varying from the scope of the invention. For example, the method may not include the step of drilling the center hole 52.

It is appreciated that during the step of selectively removing material from the peripheral edge 20 of the back-wall 22, material is only removed between the turbine blades 26 and not from the turbine blades 26 themselves. As such, either the shaft-and-wheel assembly 32 can be indexed in the circumferential direction about the axis of rotation 28 or the cutting tool can be indexed in the circumferential direction about the axis of rotation 28 without varying from the scope of the invention.

The invention has been described in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. A turbine wheel (10) for a turbocharger comprising:
a hub (12) extending in an axial direction between a nose (14) and a back-wall (22), said back-wall (22) including a peripheral edge (20), wherein said hub (12) defines an axis of rotation (28) extending in said axial direction;
a plurality of turbine blades (26) coupled to said hub (12) and disposed in a circumferential direction generally at equal intervals around said axis of rotation (28); and
at least one scallop (44, 48) formed in said peripheral edge (20) of said back-wall (22) for balancing said turbine wheel (10), wherein said at least one scallop (44, 48) is positioned along said peripheral edge (20) such that said peripheral edge (20) is not symmetrical in said circumferential direction about said axis of rotation (28).

2. The turbine wheel (10) as set forth in claim 1 wherein said at least one scallop (44, 48) is positioned in said circumferential direction between said plurality of turbine blades (26).

3. The turbine wheel (10) as set forth in claim 2 wherein said at least one scallop (44, 48) extends in said axial direction through said back-wall (22) from a surface (34) of said back-wall (22) to a deck face (42) of said hub (12).

4. The turbine wheel (10) as set forth in claim 3 wherein said at least one scallop (44) is elongated in said circumferential direction between opposite ends (46), each one of said opposite ends (46) is spaced apart from one of said plurality of turbine blades (26) by at least a first distance (C1).

5. The turbine wheel (10) as set forth in claim 4 wherein said first distance (C1) is at least approximately 0.5 millimeters.

6. The turbine wheel (10) as set forth in claim 4 including at least two scallops (48) positioned in said circumferential direction between two adjacent turbine blades (26).

7. The turbine wheel (10) as set forth in claim 2 wherein said at least one scallop (48) is generally semi-circular and includes opposite sides (50), each one of said opposite sides (50) is spaced apart from one of said plurality of turbine blades (26) by at least a second distance.

8. The turbine wheel (10) as set forth in claim 7 wherein said second distance (C2) is at least approximately 0.5 millimeters.

9. The turbine wheel (10) as set forth in claim 7 including at least two scallops (48) positioned in said circumferential direction between two adjacent turbine blades (26).

10. The turbine wheel (10) as set forth in claim 9 wherein said at least two scallops (48) are spaced apart in said circumferential direction by at least a third distance (C3).

11. The turbine wheel as set forth in claim 10 wherein said third distance (C3) is at least approximately 2.0 millimeters.

12. A method of balancing a turbocharger shaft-and-wheel assembly (32) including a turbine wheel (10) having a hub (12) extending in an axial direction between a nose (14) with side faces and a back-wall (22) with a peripheral edge (20) and a surface (34), and having a plurality of turbine blades (26) disposed in a circumferential direction generally at equal intervals around an axis of rotation (28), the method including the steps of:
removing material from the peripheral edge (20) of the back-wall (22) between the plurality of turbine blades (26) such that the peripheral edge (20) of the back-wall (22) is not symmetrical in the circumferential direction about the axis of rotation (28).

13. The method as set forth in claim 12 wherein the step of removing material from the peripheral edge (20) of the back-wall (22) includes the step of machining at least one multi-pass scallop (44) that is elongated in the circumferential direction.

14. The method as set forth in claim 13 including the step of removing material from one or more of the side faces of the nose (14).

15. The method as set forth in claim 14 including the step of removing material from the surface (34) of the back-wall (22).

16. The method as set forth in claim 12 wherein the step of removing material from the peripheral edge (20) of the back-wall (22) includes the step of machining at least one single-pass scallop (48) that is generally semi-circular.
